(19) United States
(12) Patent Application Publication
(10) Pub. No.: US 2025/0275045 A1
(43) Pub. Date: Aug. 28, 2025

(54) METHOD FOR GENERATING AND PROVIDING LIGHTING EFFECT

(71) Applicant: FANLIGHT Co., Ltd., Seoul (KR)

(72) Inventors: Kyung Il CHOI, Seoul (KR); Jung Min CHOI, Seoul (KR); Hyun Gil KIM, Seoul (KR); Ho Lim SONG, Seoul (KR)

(73) Assignee: FANLIGHT Co., Ltd., Seoul (KR)

(21) Appl. No.: 19/207,782

(22) Filed: May 14, 2025

Related U.S. Application Data
(63) Continuation of application No. PCT/KR2023/017153, filed on Oct. 31, 2023.

(30) Foreign Application Priority Data
Nov. 15, 2022 (KR) 10-2022-0152143
Mar. 10, 2023 (KR) 10-2023-0031579
Mar. 10, 2023 (KR) 10-2023-0031582

(51) Int. Cl. H05B 47/175; H04N 21/472; H05B 45/20; H05B 47/105; H05B 47/16; H05B 47/19

(52) U.S. Cl. CPC H05B 47/1985; H04N 21/47202; H05B 45/20; H05B 47/105; H05B 47/16; H05B 47/19; H05B 47/196

(57) ABSTRACT

A user device configured to produce lighting effects of a video offered through a VOD service includes: a communication unit configured to communicate with a server and a receiving device; a memory; and a processor electrically connected to the communication unit and the memory, and the processor is configured to acquire content-related information and playing time of the video, request and receive at least one piece of metadata from the server based on the content-related information, identify first metadata corresponding to the playing time among the at least one piece of metadata, generate a light emission control signal based on the first metadata, and transmit the light emission control signal to the receiving device.

### CROSS-REFERENCE TO RELATED APPLICATIONS

This application is a continuation of International Application No. PCT/KR2023/017153 filed on Oct. 31, 2023, which claims priority to Korean Patent Application No. 10-2022-0152143 filed on Nov. 15, 2022, Korean Patent Application No. 10-2023-0031579 filed on Mar. 10, 2023, and Korean Patent Application No. 10-2023-0031582 filed on Mar. 10, 2023, the entire contents of which are herein incorporated by reference.

### TECHNICAL FIELD

The present disclosure relates to a method for creating and providing lighting effects associated with a video offered through a VOD (Video On Demand) service. More specifically, the present disclosure relates to a method for producing lighting effects on a receiving device, in association with a video offered through a VOD service, using the receiving device and/or a user device.

Further, the present disclosure relates to a method for creating and providing lighting effects associated with a live-streamed performance video. More specifically, the present disclosure relates to a method for producing lighting effects on a receiving device, in association with a live-streamed performance video, using the receiving device and/or a user device.

### BACKGROUND

In general, a light emitting device (or a lighting device) refers to a device that achieves the purpose of lighting by reflecting, refracting, and transmitting light from a light source. The light emitting device may be classified into an indirect light emitting device, a semi-indirect light emitting device, a full-diffusion light emitting device, a semi-direct light emitting device, and a direct light emitting device based on light distribution.

With developments of technologies, the light emitting device is being used for various purposes. For example, the light emitting device may be installed on the exterior of a building to produce a media facade that implements media functionality. In another example, the light emitting device may be used as a portable cheering device at a performance venue for sports events or concerts with illumination at or below a specific level. Portable cheering devices can be used as a means of group cheering by a large number of audience members at a performance venue, and thus can achieve excellent cheering effects. Further, by controlling the portable cheering devices via relays installed at the performance venue to emit light of colors synchronized with various stage effects (e.g., lighting effects), the sense of immersion during the performance can be improved.

However, when a viewer watches a live-streamed video (e.g., a performance video) remotely rather than at the performance venue, or watches a recorded video or performance video through a VOD service by non-real-time methods, it becomes difficult to achieve the same level of cheering effects.

Therefore, in order to specifically solve the above-described problems, there is a growing need for a method of controlling a portable cheering device held by a remote viewer or VOD viewer, to allow the viewer to experience lighting effects similar to those in the actual performance venue.

### DISCLOSURE OF THE INVENTION

### Problems to be Solved by the Invention

The present disclosure is conceived to provide a method for creating and providing control signals to produce lighting effects on a receiving device in association with a video offered through a VOD service.

Also, the present disclosure is conceived to provide a method for creating and providing control signals to produce lighting effects on a receiving device in association with a live-streamed performance video.

However, the problems to be solved by the present disclosure are not limited to the above-described problems. Although not described herein, other problems to be solved by the present disclosure can be clearly understood by a person with ordinary skill in the art from the following descriptions.

### Means for Solving the Problems

According to the present disclosure, a user device configured to produce lighting effects of a video offered through a VOD service includes: a communication unit configured to communicate with a server and a receiving device; a memory; and a processor electrically connected to the communication unit and the memory, and the processor is configured to acquire content-related information and playing time of the video, request and receive at least one piece of metadata from the server based on the content-related information, identify first metadata corresponding to the playing time among the at least one piece of metadata, generate a light emission control signal based on the first metadata, and transmit the light emission control signal to the receiving device.

Also, according to the present disclosure, a method for producing lighting effects of a video offered through a VOD service includes: a process of acquiring, by a user device, content-related information and playing time of the video; a process of requesting, by the user device, at least one piece of metadata from a server based on the content-related information; a process of receiving, by the user device, the at least one piece of metadata from the server; a process of identifying, by the user device, first metadata corresponding to the playing time among the at least one piece of metadata and generating a light emission control signal based on the first metadata; and a process of transmitting, by the user device, the light emission control signal to the receiving device.

According to an exemplary embodiment of the present disclosure, the exemplary embodiments may be a computer program stored in a computer-readable recording medium to execute a lighting effect control method.

Further, according to the present disclosure, a user device configured to produce lighting effects of a live-streamed performance video includes: a communication unit configured to communicate with a server and a receiving device; a memory; and a processor electrically connected to the communication unit and the memory.

The processor is configured to acquire performance information and playing time of the performance video, request, from the server, first metadata corresponding to a first stage based on the performance information, download the first metadata from the server, check stage information of a stage produced in real time during the performance, generate a light emission control signal based on the playing time and the first metadata in response to the first stage being produced during the performance, and transmit the light emission control signal to the receiving device.

The processor may receive URL information of the first metadata from the server to download the first metadata, and request, from the server, a download of the first metadata based on the URL information of the first metadata. The user device may further include a display, and the processor may further be configured to receive the playing time from a user through the display.

The processor may poll for live stage information from the server at regular time intervals to check stage information being produced in real time during the performance, and receive a response from the server. The processor may further be configured to download, from the server, second metadata corresponding to a second stage while the first stage is being produced during the performance. The second stage may be predetermined to sequentially follow the first stage.

Furthermore, according to the present disclosure, a method for producing lighting effects of a live-streamed performance video includes: a process of acquiring, by a user device, performance information and playing time of the performance video; a process of requesting, by the user device, first metadata corresponding to a first stage from a server based on the performance information; a process of downloading, by the user device, the first metadata from the server; a process of checking, by the user device, stage information being produced in real time during the performance; a process of generating, by the user device, a light emission control signal based on the playing time and the first metadata in response to the first stage being produced during the performance; and a process of transmitting, by the user device, the light emission control signal to a receiving device.

The process of downloading, by the user device, the first metadata from the server may include: a process of receiving, by the user device, URL information of the first metadata from the server; and a process of requesting, by the user device, a download of the first metadata from the server based on the URL information of the first metadata.

The process of acquiring the playing time may include a process of receiving, by the user device, the playing time from a user through a display.

The process of checking, by the user device, the stage information being produced in real time during the performance may include a process of polling, by the user device, for live stage information from the server at regular time intervals and receiving a response from the server.

The method may further include a process of downloading, by the user device, second metadata corresponding to a second stage from the server while the first stage is being produced during the performance, and the second stage may be predetermined to sequentially follow the first stage.

The first metadata may include at least one piece of color information and at least one timecode.

The performance information may include at least one of performance ID, performance title, performance date and time, and at least one piece of stage information.

The process of generating, by the user device, the light emission control signal may include: a process of requesting, by the user device, a download of third metadata corresponding to newly acquired playing time from the server, upon acquiring the new playing time; and a process of generating the light emission control signal based on the newly acquired playing time and the third metadata.

The receiving device includes a processor, a memory, and a light emitting unit, and the processor may be configured to emit light of a color corresponding to the light emission control signal through the light emitting unit.

The receiving device may be a toy including at least one joint with adjustable positioning and a processor and further including at least one of a drive motor configured to drive the at least one joint, a light emitting unit, or a speaker. The processor may be configured to receive at least one of the light emission control signal, an operation control signal, or a sound control signal from the user device, emit light of a color corresponding to the light emission control signal through the light emitting unit upon receiving the light emission control signal, drive the at least one joint to perform a predetermined operation upon receiving the operation control signal, and output sound through the speaker based on the sound control signal upon receiving the sound control signal.

Details of other embodiments of the present disclosure will be included in the detailed description and the accompanying drawings.

### Effects of the Invention

According to a method for creating and providing lighting effects of the present disclosure, a user device can download metadata corresponding to a video offered through a VOD service and generate a control signal for producing lighting effects of the video on a receiving device based on the metadata. Thus, the user's immersion in viewing a performance can be improved.

Further, according to the method for creating and providing lighting effects of the present disclosure, the user device can download metadata corresponding to a live-streamed video and generate a control signal for producing lighting effects of the performance video on the receiving device based on the metadata. Thus, the user's immersion in viewing the performance can be improved.

Furthermore, the effects of the present disclosure are not limited to the above-described effects. Although not described herein, other effects of the present disclosure can be clearly understood by a person with ordinary skill in the art from the following descriptions.

### BRIEF DESCRIPTION OF THE DRAWINGS

FIG. 1 is a conceptual diagram illustrating a metadata generation system according to an embodiment of the present disclosure.

FIG. 2 is a conceptual diagram illustrating a lighting effect production system according to an embodiment of the present disclosure.

FIG. 3 shows a performance timeline according to an exemplary embodiment of the present disclosure.

FIG. 4 shows a performance information screen according to an exemplary embodiment of the present disclosure.

FIG. 5 is a signal flowchart between a server, a user device, and a receiving device according to an embodiment of the present disclosure.

FIG. 6 and FIG. 7 are signal flowcharts between the server, the user device, and the receiving device according to an embodiment of the present disclosure.

FIG. 8 shows an application screen according to an exemplary embodiment of the present disclosure.

FIG. 9 is a block diagram illustrating the user device according to an exemplary embodiment of the present disclosure.

FIG. 10 is a block diagram illustrating the receiving device according to an exemplary embodiment of the present disclosure.

FIG. 11 is a block diagram illustrating the receiving device in the form of a toy according to an exemplary embodiment of the present disclosure.

### MODE FOR CARRYING OUT THE INVENTION

The above and other aspects, features and advantages of the present disclosure will become apparent from the following description of the following embodiments given in conjunction with the accompanying drawings. The present disclosure, however, may be embodied in various different forms, and should not be construed as being limited only to the illustrated embodiments. Rather, these embodiments are provided as examples so that the present disclosure will be thorough and complete, and will fully convey the scope of the present disclosure to a person with ordinary skill in the art. The present disclosure may be defined by the scope of the claims.

The terms used herein are provided to describe embodiments, not intended to limit the present disclosure. In the specification, the singular forms include plural forms unless particularly mentioned. The terms “comprises” and/or “comprising” used herein do not exclude the presence or addition of one or more other components, in addition to the aforementioned components. The same reference numerals denote the same components throughout the specification. As used herein, the term “and/or” includes each of the associated components and all combinations of one or more of the associated components. It will be understood that, although the terms “first”, “second”, etc., may be used herein to describe various components, these components should not be limited by these terms. These terms are only used to distinguish one component from another component. Thus, a first component that is discussed below could be termed a second component without departing from the technical idea of the present disclosure.

A word “exemplary” is used herein in the sense of “being used as an example or illustration”. An embodiment described herein as “exemplary” is not necessarily to be construed as preferred or advantageous over other embodiments.

Embodiments of the present disclosure may be described in terms of a function or a block performing a function. A block capable of being referred to as a “unit” or a “module” of the present disclosure is physically implemented by analog or digital circuits such as logic gates, integrated circuits, microprocessors, microcontrollers, memories, passive electronic components, active electronic components, optical components, hardwired circuits, and the like and may be selectively driven by firmware and software. The term “unit” used herein may refer to software or hardware such as field programmable gate array (FPGA) or application specific integrated circuit (ASIC), and the “unit” may perform some functions. However, the “unit” may be not limited to software or hardware. The “unit” may be configured to exist in an addressable storage medium or may be configured to reproduce one or more processors. Therefore, as an example, “units” may include various elements such as software elements, object-oriented software elements, class elements, and task elements, processes, functions, attributes, procedures, subroutines, program code segments, drivers, firmware, microcodes, circuits, data, databases, data structures, tables, arrays, and variables. Functions provided in “units” and elements may be combined into a smaller number of “units” and elements or may be divided into additional “units” and elements.

Embodiments of the present disclosure may be implemented by using at least one software program running on at least one hardware device and may perform a network management function of controlling an element.

As illustrated in the figures, spatially relative terms, such as “below”, “beneath”, “lower”, “above”, “upper”, and the like, may be used herein for ease of description to describe the relationship between one component and other components.

It will be understood that the spatially relative terms are intended to encompass different orientations of the components in use or operation in addition to the orientation depicted in the figures. For example, when inverting a component shown in the figures, a component described as “below” or “beneath” of another component may be placed “above” another element. Thus, the exemplary term “below” may include both downward and upward directions. The components may also be oriented in different directions, and thus the spatially relative terms may be interpreted depending on orientation. Unless otherwise defined, all terms (including technical and scientific terms) used herein have the same meaning as commonly understood by a person with ordinary skill in the art to which the present disclosure pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, embodiments of the present disclosure will be described in detail with reference to the accompanying drawings.

Meanwhile, a video according to the present disclosure is associated with specific content, and the specific content refers to an event in which a plurality of audience members participates, such as a performance, an occasion, or a lecture. In the following description, the content is assumed to be a performance event in order to provide a clearer and more concrete explanation of the present disclosure. The content according to the present disclosure is not limited to performances alone, but may include any event involving a plurality of audience members. Also, content-related information may refer to performance information to be described below.

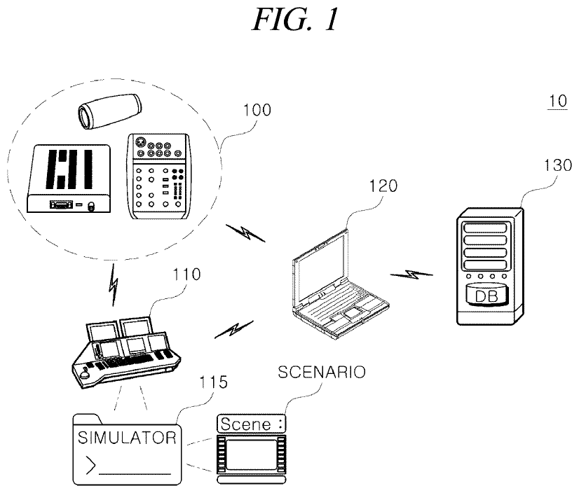

FIG. 1 is a conceptual diagram illustrating a metadata generation system according to an embodiment of the present disclosure.

Referring to FIG. 1, a metadata generation system 10 according to an embodiment of the present disclosure may include a timecode generation device 100, a stage production device 110, a metadata generation device 120, and/or a server 130. In an embodiment, the stage production device 110 may include a simulator 115 configured to express, conceive, and design a scenario.

In an embodiment, the timecode generation device 100 may include a laptop computer, a speaker, and/or a mixer. The timecode generation device 100 may generate an SMPTE for synchronization of lighting effects. The timecode generation device 100 shown in FIG. 1 is exemplary, but is not intended to be limiting.

In an embodiment, the stage production device 110 may generate a control signal to produce lighting effects at a performance venue. Stage settings (e.g., a sound system and a lighting system) installed at the performance venue may produce various effects (e.g., sound effects and lighting effects) based on the control signal from the stage production device 110. For example, the stage production device 110 may be one of software programs for PC or an electronic device, such as MA Lighting grandMA2, grandMA3, ETC EOS, ETC ION, ETC GIO, Chroma Q Vista, High End HOG, High End Fullboar, Avolites Sapphire Avolites Tiger, Chamsys MagicQ, Obsidian control systems Onyx, Martin M6, Martin M1, Nicolaudie Sunlite, ESA, ESA2, Lumidesk, SunSuite, Arcolis, Daslight, LightRider, MADRIX, DJ LIGHT STUDIO, DISCO-DESIGNER VJ STUDIO, Stagecraft, Lightkey, and the like.

The stage production device 110 may include the simulator 115 configured to produce lighting effects. The simulator 115 may be an electronic device that implements virtual simulation for implementing lighting effects, software that runs on the electronic device, or a complex device that combines the software and the electronic device. For example, a user may input an electronic signal corresponding to a scene to be produced on the simulator 115. The simulator 115 may convert the input electronic signal to conform to the protocol of the stage production device 110 and may provide the converted electronic signal to the stage production device 110 so as to be driven by the stage production device 110.

In an exemplary embodiment, the stage production device 110 may include appropriate software or computer program for controlling the stage settings. For example, the stage production device 110 may include, as an exemplary protocol for controlling the stage settings, DMX512, RDM, Art-Net, sACN, ETC-Net2, Pathport, Shownet, or KiNET. The stage production device 110 may transmit a data signal (e.g., a light emission control signal) in an appropriate format, such as DMX512, Art-Net, sACN, ETC-Net2, Pathport, Shownet, or KiNET.

In an exemplary embodiment, the stage production device 110 may include a plurality of input/output ports. The stage production device 110 may be equipped with an input/output port corresponding to or related to a specific data signal format or protocol. For example, the stage production device 110 may be equipped with a first port dedicated to DMX512 and RDM data input/output and a second port dedicated to Art-Net and sACN, ETC-Net2, Pathport, Shownet, KiNET data input/output. The DMX512, RDM, Art-Net, sACN, ETC-Net2, Pathport, Shownet and KiNET protocols are widely known as control protocols for stage lighting installations. According to exemplary embodiments of the present disclosure, the stage production device 110 may use control protocols, such as DMX512, RDM, Art-Net, sACN, ETC-Net2, Pathport, Shownet, and KiNET, to perform flexible control planning for the stage settings.

In an embodiment, a director of the performance may use the stage production device 110 to previously generate control data for at least the lighting effects intended to be produced during the actual performance.

In a case where the performance is composed of a plurality of stages, control data corresponding to each of the plurality of stages may be generated. It can be understood that the control data has been generated in advance to produce lighting effects for the respective stages in the actual performance venue.

In an embodiment, the metadata generation device 120 may include a laptop computer.

The metadata generation device 120 may receive a timecode from the timecode generation device 100. The metadata generation device 120 may receive the control data from the stage production device 110. The metadata generation device 120 may generate metadata for the stages by synchronizing the timecode with the control data. The metadata generation device 120 may transmit the generated metadata to the server 130.

In an embodiment, the metadata may be composed of an identification number, a timecode, and color information for lighting effects (e.g., RGBW data). This is just an example, but does not limit the embodiments of the present disclosure. For example, a first identification number (e.g., #1) may indicate a first lighting effect (e.g., a first lighting effect) produced on the stage. More specifically, the first identification number may be mapped to timecodes indicating start and end times of the first lighting effect as well as to color information for the first lighting effect. The identification number may increment by one each time the lighting effect changes. Each identification number may be mapped to timecodes indicating the start and end times of the corresponding lighting effect (e.g., a second lighting effect or a third lighting effect) as well as to color information for the corresponding lighting effect.

In an embodiment, the metadata may be identified by timecodes indicating the start and end times of the corresponding stage. For example, the start time of the metadata may correspond to a timecode of the point where the lighting effect associated with the first identification number begins. Similarly, the end time of the metadata may correspond to a timecode of the point where the lighting effect associated with the last identification number ends.

In an embodiment, the server 130 may receive the metadata from the metadata generation device 120 and store the received metadata in a database DB. For example, the server 130 may provide performance data to the stage production device 110 through a wired network method such as a coaxial cable or a wired local area network (LAN) (e.g., Ethernet). For example, on a mobile communication network built according to a mobile communication standard communication method, the server 130 may provide performance data in the form of a packet to the stage production device 110. For example, the database DB stored in the server 130 may be physically installed into the stage production device 110 through a storage medium such as a removable disk.

In an embodiment, when a plurality of stages is produced during a single performance, a plurality of pieces of metadata corresponding to the respective stages may be generated. The plurality of pieces of metadata (e.g., first metadata and second metadata) may be generated based on a series of consecutive timecodes, or may be generated based on an independent timecode.

In an embodiment, after the production of a first stage in the performance ends, a second stage may be produced consecutively. In this case, the first stage may correspond to first metadata, and the second stage may correspond to second metadata. For example, an end timecode for the first metadata may match a start timecode for the second metadata. In another example, after the production of the stage corresponding to the first metadata ends, the start timecode for the second metadata may be independent of the end timecode for the first metadata. Hereinafter, it is assumed that the plurality of pieces of metadata is generated based on a series of consecutive timecodes.

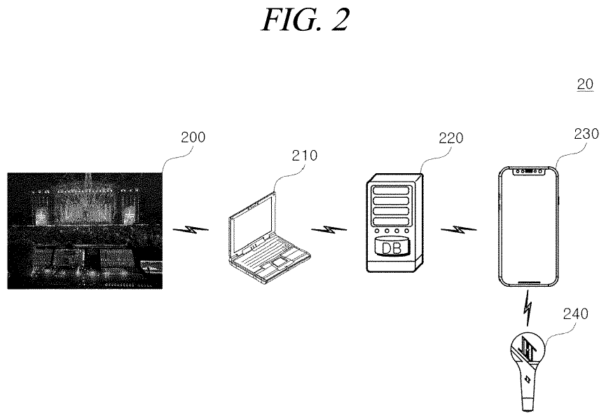

FIG. 2 is a conceptual diagram illustrating a lighting effect production system according to an embodiment of the present disclosure.

Referring to FIG. 2, a lighting effect production system 20 according to an embodiment of the present disclosure may include a performance venue 200, a trigger device 210, a server 220, a user device 230, and/or a receiving device 240.

In an embodiment, the user can view a video on the user device 230.

For example, the video may include at least one of a performance video from the performance venue 200, a video streamed via a video-sharing platform (e.g., YouTube™), and media content (e.g., a music video, an animation, or a drama). In the following description, the video is assumed to be a performance video in order to provide a clearer and more concrete explanation of the present disclosure. The video according to the present disclosure is not limited to performance videos alone, and video-related information may refer to performance information to be described below.

In an embodiment, lighting effects based on previously generated control data may be produced at the performance venue 200. The director may transmit a control signal based on the previously generated control data to the stage settings through the stage production device 110 installed at the performance venue 200. For example, a lighting device may provide a lighting effect (e.g., light emission) according to the control signal.

In an embodiment, a time period from the start to the end of the actual performance at the performance venue 200 may be defined as a performance timeline. On the performance timeline, at least one stage may be produced, and a break time may exist between the stages. For example, the break time may be the time for speech of the host or the preparation time for the next stage.

In an embodiment, the trigger device 210 may trigger, on the performance timeline, at least one piece of metadata corresponding to the stages produced at the performance venue 200. The trigger device 210 may generate performance production information by synchronizing the at least one piece of metadata with the performance timeline based on the trigger timing.

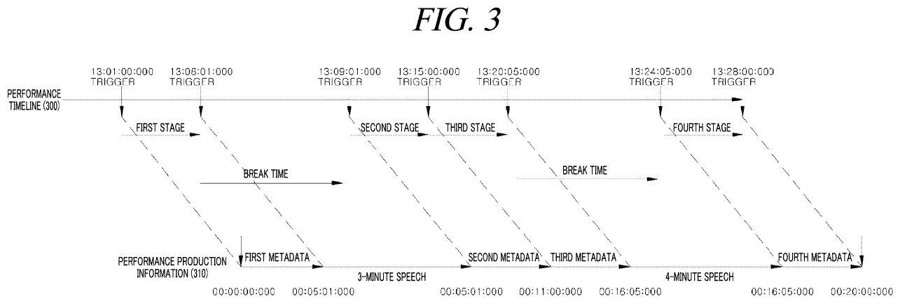

Referring to FIG. 3, a performance timeline 300 may represent a time period during which at least one stage was produced at the performance venue 200. The performance timeline 300 may be in local standard time (e.g., Korea Standard Time (KST)) and/or UNIX time. According to the embodiment shown in FIG. 3, it can be understood that four stages (e.g., a first stage, a second stage, a third stage, and a fourth stage) are produced at the performance venue 200. The break time may exist between the first and second stages and between the third and fourth stages.

In an embodiment, the stages to be produced in real time at the performance venue 200 (e.g., the first stage, the second stage, the third stage, and the fourth stage) may be previously determined. Therefore, during the actual performance, the director may produce lighting effects according to a predetermined sequence of stages. The control data for producing lighting effects for the respective stages may be based on the metadata generated as shown in FIG. 1.

The trigger device 210 may trigger, on the performance timeline 300, metadata corresponding to time points where the respective stages are produced. For example, the first metadata may be triggered at a time point (13:01:00:000) where the first stage is produced. For example, the second metadata may be triggered at a time point (13:09:01:000) where the second stage is produced. For example, the third metadata may be triggered at a time point (13:15:00:000) where the third stage is produced. For example, the fourth metadata may be triggered at a time point (13:24:05:000) where the fourth stage is produced.

The trigger device 210 may generate performance production information 310 by synchronizing at least one piece of metadata with the performance timeline based on the trigger timing. In an embodiment, the at least one piece of metadata may have a predefined timecode independent of the performance timeline 300.

In an embodiment, the trigger device 210 may map the timecode of the at least one piece of metadata to the performance timeline 300. For example, the trigger device 210 may map a start timecode (00:05:01:000) of the second metadata to the performance time (13:09:01:000) of the second stage on the performance timeline 300.

Referring back to FIG. 2, the trigger device 210 may transmit the generated performance production information to the server 220. The server 220 may store the received performance production information in a database as performance information along with various other details related to the performance (e.g., performance title, performance date and time, and organizer name). Descriptions of the server 220 may refer to the descriptions of the server 130 of FIG. 1. However, the server 220 and the server 130 may be separate servers located physically apart.

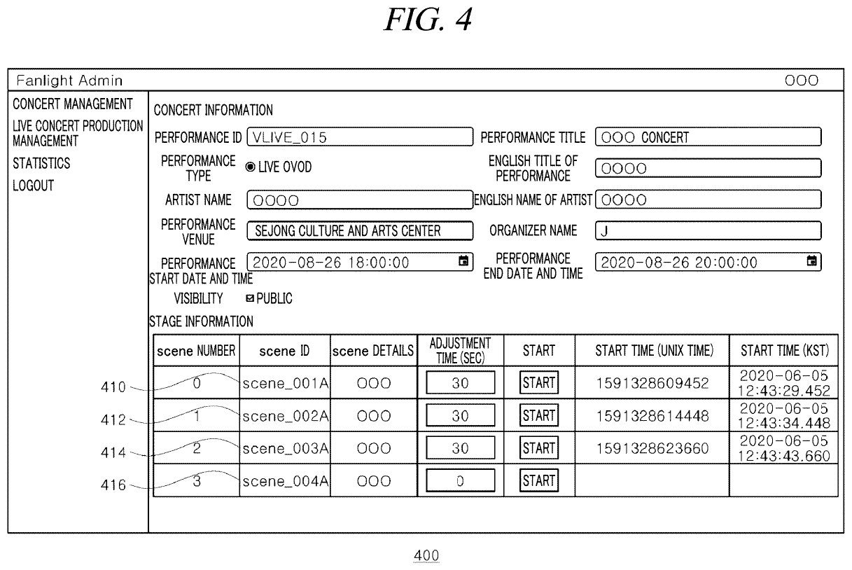

Referring to FIG. 4, the performance information stored in the server 220 may be provided through an administrator interface, as shown on a screen 400.

Referring to the screen 400, the performance production information may include various performance-related details, such as performance ID, performance title, English title, performance type, performance venue, performance date and time, and stage information.

On the screen 400, the performance type may indicate whether the performance is offered to the user as a live-streamed event or as a VOD service. In the present disclosure, a performance video can be understood as a video offered through a VOD service after the end of the actual performance. Also, in the present disclosure, the performance video can be understood as a live-streamed video of the performance taking place at the performance venue, intended for remote users.

On the screen 400, the stage information may display detailed information about the plurality of stages produced during the performance. The stage information of each stage may include the start time of the stage production in both KST time and UNIX time.

In an embodiment, it can be understood that a first stage 410, a second stage 412, and a third stage 414 began at 12:43:29, 12:43:34, and 12:43:43 KST, respectively. Also, it can be understood that a fourth stage 416 is scheduled to be produced during the performance but has not yet started. When the fourth stage 416 is produced, the trigger device 210 may transmit the start time of the production to the server to update the screen 400.

Referring back to FIG. 2, the user may remotely view the performance video from the performance venue 200 either through a VOD service or via a live streaming service. For example, the user may view the performance video from the performance venue 200 by means of the user device 230 or another separate electronic device equipped with a display (not shown).

In an embodiment, while watching the performance video, the user may use the user device 230 and the receiving device 240 to experience cheering effects similar to those in the actual performance venue. A specific configuration of the user device 230 and the receiving device 240 will be described below.

In an embodiment, the user device 230 may be an electronic device, such as a mobile phone, a smart phone, a laptop computer, a digital broadcasting device, a personal digital assistant (PDA), a portable multimedia player (PMP), a navigation system, a slate PC, a tablet PC, an ultrabook, and a wearable device (e.g., a smartwatch), a glasses-type device (e.g., smart glasses), a head mounted display (HMD), or the like, but is not limited thereto.

In an embodiment, the receiving device 240 may include a light emitting element, such as a liquid crystal display (LCD) or a light emitting diode (LED), or may be connected to the light emitting element. The receiving device 240 may include any electronic device capable of wireless communication. The receiving device 240 may be a small cheering device carried by an audience member at the performance venue for sports events or concerts. For example, the receiving device 240 may be a mobile phone, a wireless receiving device, a lighting stick, a lighting bar, a lighting ball, a lighting panel, and a device equipped with a light source that is wirelessly controllable. In the present disclosure, the receiving device 240 may be referred to as a lighting device, a receiver, a controlled device, a slave, or a slave lighting device. Also, the receiving device 240 may include a wearable device to be attached to and/or worn on a part of the body, such as wrist or chest.

In an embodiment, the user device 230 may receive at least one piece of metadata from the server 220 to produce lighting effects. In an embodiment, the at least one piece of metadata may be received in the format of JavaScript Object Notation (JSON). Also, in an embodiment, the at least one piece of metadata may be received in the format of Uniform Resource Locator (URL).

In an embodiment, the user device 230 may acquire playing time of the performance video being viewed by the user. The playing time may refer to a time point of the scene being viewed by the user on the performance timeline. The playing time may be the same as the actual time at the performance venue or may be delayed compared to the actual time due to network data transmission delays. For example, the user device 230 may acquire the playing time from an electronic device (e.g., a user device or an external electronic device) on which the user is viewing the performance video.

For example, the user device 230 may receive the playing time from the user through the display.

In an embodiment, the user device 230 may identify metadata (e.g., first metadata) corresponding to the playing time from among the received at least one piece of metadata. For example, the first metadata may indicate at least one lighting effect. The user device 230 may generate a light emission control signal based on the first metadata. For example, the light emission control signal may correspond to a lighting effect produced on the stage for a predetermined period of time in the playing time.

In an embodiment, the user device 230 may acquire stage information of a live performance being produced at the performance venue 200 and download, from the server 220, metadata corresponding to the currently presented or scheduled stage. The user device 230 may generate a light emission control signal based on the downloaded metadata. For example, the light emission control signal may correspond to a lighting effect produced on the stage for a predetermined period of time in the playing time.

In an embodiment, the user device 230 may transmit the generated light emission control signal to the receiving device 240. The receiving device 240 may emit light of a color corresponding to a light emission control signal through a light emitting unit.

In an embodiment, when the user device 230 acquires new playing time, the user device 230 may identify metadata (e.g., second metadata) corresponding to the playing time from among the received at least one piece of metadata and generate a light emission control signal based on the second metadata. The user device 230 may transmit the newly generated light emission control signal to the receiving device 240.

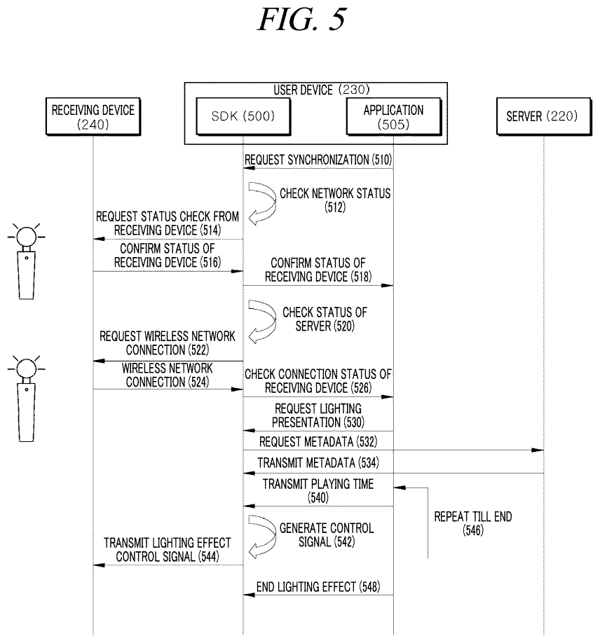

Descriptions of specific operations of the server 220, the user device 230, and the receiving device 240 may refer to the descriptions of FIG. 5 to FIG. 7.

FIG. 5 is a signal flowchart between the server 220, the user device 230, and the receiving device 240 according to an embodiment of the present disclosure.

In an embodiment, the user device 230 may include a Software Development Kit (SDK) 500 and an application 505. For example, the SDK 500 and the application 505 may be stored in a memory of the user device 230. In an embodiment, the SDK 500 may be distributed by the developer of the metadata generation system. In an embodiment, the application 505 can be understood as an application related to the viewing of videos (e.g., performance videos). The operations of the SDK 500 and the application 505 shown in FIG. 5 may be performed substantially by a processor of the user device 230.

In an embodiment, the application 505 may request synchronization with the SDK 500 (510). For example, the application 505 may transmit performance information (e.g., performance ID) of the performance being viewed by the user to the SDK 500 for synchronization. The application 505 may identify the performance information of the performance video being played on the user device 230 or acquire the performance information from an external electronic device that is playing the performance video.

The SDK 500 may check the status of a network (e.g., cellular, Bluetooth) in response to the request for synchronization (512) and request a status check from the receiving device 240 (514). The receiving device 240 may transmit a status confirmation signal to the SDK 500. For example, the status confirmation signal may indicate that the receiving device 240 can be connected to the SDK 500 via a wireless network (e.g., Bluetooth™).

The SDK 500 may transmit the status confirmation signal from the receiving device 240 to the application 505 (518) and check the status of the server 220 (520). For example, the SDK 500 may confirm that the user device 230 can communicate with the server 220 via a stable network.

The SDK 500 may request a wireless network connection (e.g., Bluetooth™) from the receiving device 240 (522). The receiving device 240 may be wirelessly connected to the user device 230 in response to the request for wireless network connection (524).

The SDK 500 may check the connection status of the receiving device 240 through the application 505 (526). For example, the SDK 500 may transmit, to the application 505, a signal indicating that the user device 230 is wirelessly connected to the receiving device 240.

The application 505 may request lighting presentation from the SDK 500 (530). The lighting presentation may refer to lighting effects being produced in the performance video being viewed by the user.

In response to the request for lighting presentation, the SDK 500 may request at least one piece of metadata from the server 220 (532). The server 220 may transmit at least one piece of metadata to the SDK 500 in response to the request for metadata (534). In an embodiment, when the performance production information of the performance being viewed by the user includes a plurality of pieces of stage information, the server 220 may transmit a plurality of pieces of metadata corresponding to each of the plurality of pieces of stage information. The at least one piece of metadata may be based on the format of JSON.

The application 505 may transmit playing time to the SDK 500 (540). The playing time may refer to a time point of the scene being viewed by the user on the performance timeline.

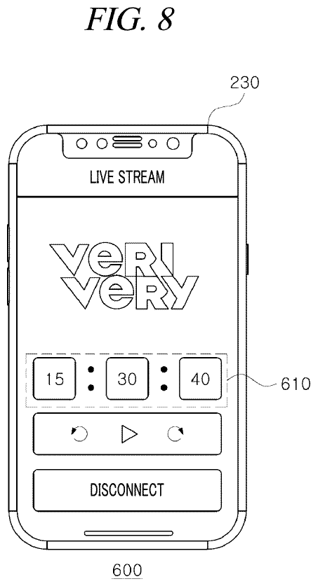

In an embodiment, the user device 230 may receive the playing time from the user through the display. Referring to FIG. 8, a screen 600 may refer to the screen of the application 505 on the display of the user device 230. The user may input the playing time through an input region 610. For example, the user may check the time displayed in the performance video being viewed and input it into the input region 610.

Referring back to FIG. 5, the SDK 500 may identify the metadata corresponding to the playing time from among at least one piece of metadata and generate a control signal based on the identified metadata (542).

The SDK 500 may transmit the control signal to the receiving device 240 (544). The receiving device 240 may emit light of a color corresponding to the light emission control signal through the light emitting unit. The operations 540 to 544 may be repeated until the performance video ends (546).

When the application 505 confirms the end of the performance video, it may request the end of lighting effects from the SDK 500 (548).

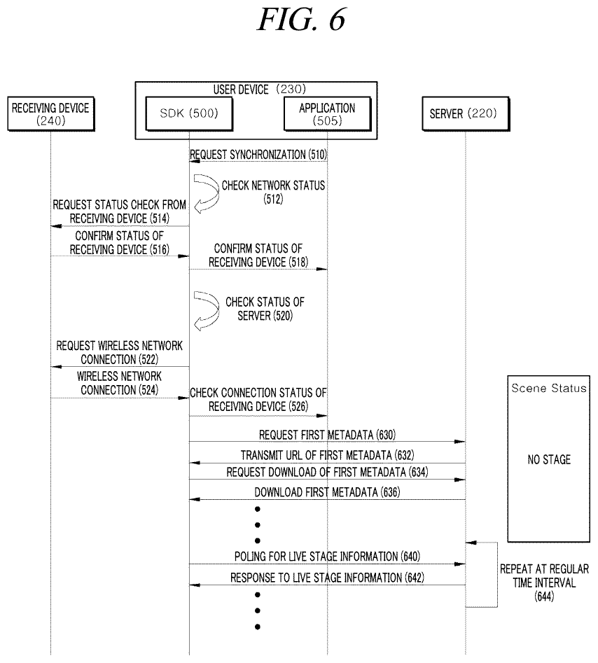

In FIG. 6, the same components as in FIG. 5 will be omitted from the explanation.

The SDK 500 may request the first metadata from the server 220 (630). It can be understood that when the SDK 500 requests the first metadata from the server 220, no stage performance is being produced at the performance venue 200. A signal of request for the first metadata may include performance information (e.g., performance ID). The first metadata may correspond to metadata for a stage (e.g., a first stage) previously scheduled to be produced first during the performance. The server 220 may transmit a URL of the first metadata to the SDK 500 based on the performance information (632). The SDK 500 may request a download of the first metadata from the server 220 based on the URL of the first metadata (634). The SDK 500 may download the first metadata from the server 220 (636).

The SDK 500 may poll for live stage information from the server 220 (640). This can be understood as an operation to check whether the next stage (e.g., the first stage) has started. The server 220 may transmit a response to the polling for the live stage information to the SDK 500 (642). If a performance of the first stage has not yet started at the performance venue 200, the SDK 500 may repeat the operations 640 to 642 at regular time intervals (644). For example, to distribute traffic concentrated on the server, the SDK 500 may repeat the operations 640 to 642 at random time intervals of 3 to 5 seconds (544).

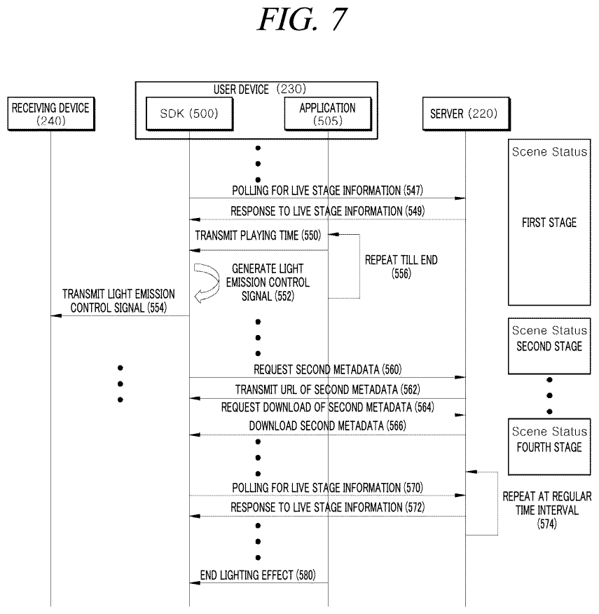

Referring to FIG. 7, when the performance of the first stage starts, the SDK 500 may receive a response 549 indicating that the performance of the first stage has started in response to a polling 547. In an embodiment, when the performance of the first stage starts, an administrator of the server 220 may update the performance production information stored in the server 220. For example, the administrator may update a stage information region on the screen 400 of FIG. 4. In another embodiment, the update of the performance production information may be automatically performed by a program (e.g., a Windows-based program) installed on the server 220. The program may be linked to the system 20 for the performance venue 200.

The application 505 may transmit the playing time to the SDK 500 (550). The playing time may refer to a time point of the scene being viewed by the user on the performance timeline

In an embodiment, the user device 230 may receive the playing time from the user through the display. Referring to FIG. 8, the screen 600 may refer to the screen of the application 505 on the display of the user device 230. The user may input the playing time through the input region 610. For example, the user may check the time displayed in the performance video being viewed and input it into the input region 610.

Referring back to FIG. 7, the SDK 500 may generate a light emission control signal based on the playing time and the first metadata (552). The SDK 500 may transmit the light emission control signal to the receiving device 240 (554). The receiving device 240 may emit light of a color corresponding to the light emission control signal through the light emitting unit. The operations 550 to 554 may be repeated until the performance of the first stage ends (556).

While the first stage is being produced at the performance venue 200, the operations 560 to 566 may be performed. The SDK 500 may request second metadata from the server 220 (560). It can be understood that the operation 560 is performed to download metadata in advance to produce lighting effects for the second stage. The server 220 may transmit a URL of the second metadata to the SDK 500 based on the performance information (562). The SDK 500 may request a download of the second metadata from the server 220 based on the URL of the second metadata (564). The SDK 500 may download the second metadata from the server 220 (566).

The SDK 500 may poll for live stage information from the server 220 (570). This can be understood as an operation to check whether the next stage (e.g., the second stage) has started. The server 220 may transmit a response to the polling for the live stage information to the SDK 500 (572). If a performance of the second stage has not yet started at the performance venue 200, the SDK 500 may repeat the operations 570 to 572 at regular time intervals. For example, to distribute traffic concentrated on the server, the SDK 500 may repeat the operations 570 to 572 at random time intervals of 3 and 5 seconds (574).

The operations related to the above-described first stage (operations 546 to 574) may be repeated until the production of all the stages (e.g., from the first stage to the fourth stage) predetermined for the performance is completed. In an embodiment, when the production of all the stages is completed, the application 505 may request the end of lighting effects from the SDK 500 (580).

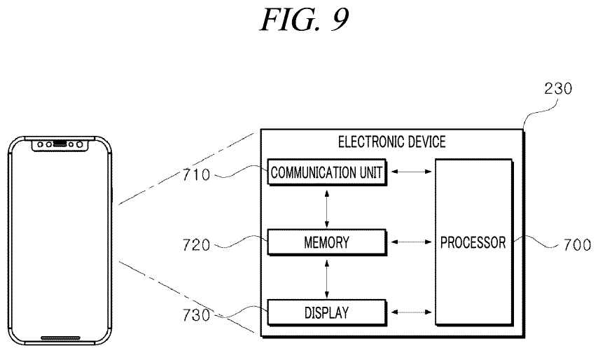

FIG. 9 is a block diagram illustrating the user device 230 according to an exemplary embodiment of the present disclosure.

The user device 230 may include a processor 700, a communication unit 710, a memory 720, and/or a display 730.

The processor 700 may control overall operations of the user device 230 and, in more detail, may control operations of the remaining components implementing the user device 230. The processor 700 may be implemented with a general-purpose processor, a special-purpose processor, or an application processor. In an exemplary embodiment, the processor 700 may be implemented as an operation processor (e.g., a central processing unit (CPU), a graphic processing unit (GPU), an application processor (AP), and the like) including dedicated logic circuits (e.g., a field programmable gate array (FPGA), application specific integrated circuits (ASICs), and the like), but is not limited thereto.

The communication unit 710 may communicate with various types of external devices depending on various types of communication methods. The communication unit 710 may include at least one of a wireless-fidelity (WiFi) chip, a Bluetooth™ chip, a wireless communication chip, a near field communication (NFC) chip, and a radio frequency identification (RFID) chip.

According to the mobile communication technology of the present disclosure, the communication unit 710 may transmit and receive a wireless signal to and from at least one of a base station, an external device, and an external server on a mobile communication network established depending on technical standards or communication methods (e.g., global system for mobile communication (GSM), code division multi access (CDMA), code division multi access 2000(CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), and the like).

Further, the wireless technologies of the present disclosure includes, for example, wireless LAN (WLAN), Wireless-Fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and the like.

Furthermore, the communication technology of the present disclosure may include a communication support technology by using at least one of Bluetooth™, radio frequency identification (RFID), infrared data association (IrDA), ultra wide band (UWB), ZigBee, near field communication (NFC), Wi-Fi, Wi-Fi Direct, wireless universal serial bus (USB), transistor-transistor logic (TTL), USB, IEEE1394, Ethernet, musical instrument digital interface (MIDI), RS232, RS422, RS485,optical communication, and coaxial cable communication.

The memory 720 may be a local storage medium supporting various functions of the user device 230. The memory 720 may store data and instructions for an operation of the user device 230. At least a part of an application program may be downloaded from an external device (e.g., the server 130) through wireless communication. The application program may be stored in the memory 720, may be installed on the user device 230, and may be driven by the processor 700 to perform an operation (or function) of the user device 230. In an embodiment, the memory 720 may include the SDK 500 and the application 505 shown in FIG. 5.

The memory 720 may be a dynamic random access memory (DRAM) such as a double data rate synchronous dynamic random access memory (DDR SDRAM), a low power double data rate (LPDDR) SDRAM, a graphics double data rate (GDDR) SDRAM, a rambus dynamic random access memory (RDRAM), DDR2 SDRAM, DDR3 SDRAM, or DDR4 SDRAM.

However, the embodiments of the present disclosure need not be limited thereto. In an exemplary embodiment, even when a power supply to the stage production device 110 is cut off, data needs to be stored in the memory 720. Accordingly, the memory 720 may be provided as a writable non-volatile memory to reflect changes. However, the present disclosure is not limited thereto. For example, a flash memory, EPROM or EEPROM, resistive memory cells such as a resistive RAM (ReRAM), a phase change RAM (PRAM), a magnetic RAM (MRAM), a spin-transfer torque MRAM, a conductive bridging RAM (CBRAM), a ferroelectric RAM (FeRAM), and other types of memory may be applied to the memory 720. Alternatively, the memory 720 may be implemented with various types of devices such as an embedded multimedia card (eMMC), universal flash storage (UFS), compact flash (CF), secure digital (SD), micro secure digital (Micro-SD), mini secure digital (Mini-SD), extreme digital (xD), or memory stick. For convenience of description in the present disclosure, it is described that all pieces of instruction information are stored in the single memory 720. However, the present disclosure is not limited thereto. For example, the memory 720 may be equipped with a plurality of memories.

The display 730 displays (outputs) information to be processed in the user device 230.

For example, the display 730 may display execution screen information of an application program (e.g., an application) running on the present device, or UI (User Interface) and GUI (Graphic User Interface) information corresponding to the execution screen information.

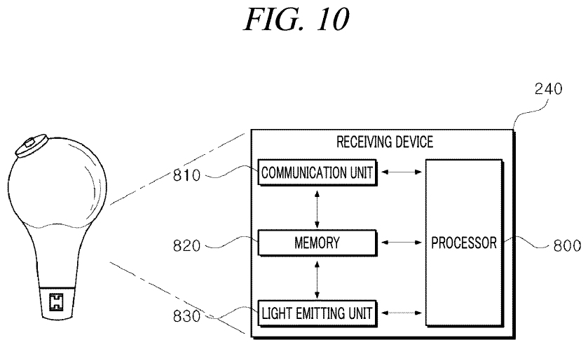

FIG. 10 is a block diagram illustrating the receiving device according to an exemplary embodiment of the present disclosure.

The receiving device 240 may include a processor 800, a communication unit 810, a memory 820, and a light emitting unit 830. Descriptions of the processor 800, the communication unit 810, and the memory 820 may refer to the descriptions of the processor 700, the communication unit 710, and the memory 720, respectively, of FIG. 9.

The light emitting unit 830 may include one or more light source elements. The light source elements may be, for example, light emitting diodes (LEDs), or the like. Also, the light emitting unit 830 may output light of various colors corresponding to RGB color information by using the light source elements.

In an embodiment, the processor 800 may receive a control signal from the user device 230 through the communication unit 810 and may emit light of a color corresponding to the light emission control signal through the light emitting unit 830.

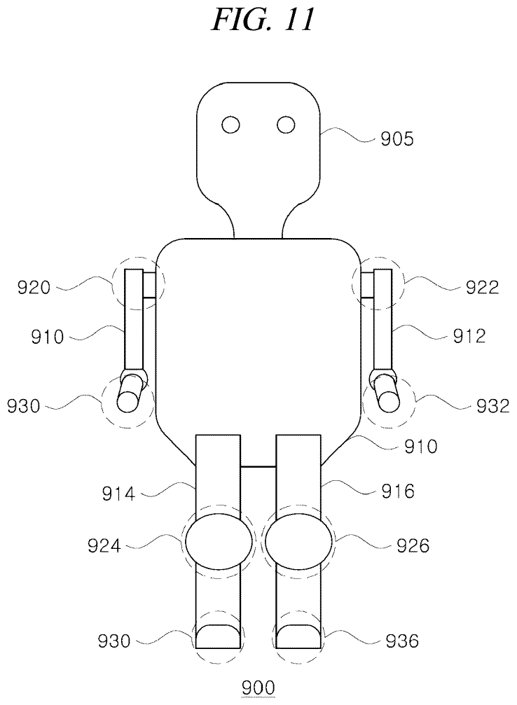

FIG. 11 is a block diagram illustrating the receiving device in the form of a toy according to an exemplary embodiment of the present disclosure.

In an embodiment, the receiving device 240 may be implemented as a toy such as a transforming robot 900. The shape of the transforming robot 900 is just an example, but does not limit the embodiments of the present disclosure.

In an embodiment, the transforming robot 900 may be composed of a head portion 905, a torso portion 910, and at least one limb portion 910, 912, 914 and 916. The transforming robot 900 may include a plurality of joint portions 920, 922, 924 and 926 that connects the torso portion 910 to the at least one limb portion 910, 912, 914 and 916. Also, the transforming robot 900 may include a plurality of end portions 930, 932, 934 and 936 attached to the at least one of the limb portions 910, 912, 914 and 916. In an embodiment, the transforming robot 900 may include at least one light emitting unit (e.g., the light emitting unit 830 of FIG. 8). For example, the at least one light emitting unit may be arranged on at least one of the plurality of joint portions 920, 922, 924 and 926. For example, the at least one light emitting unit may be arranged on at least one of the plurality of end portions 930, 932, 934 and 936. The position of the at least one light emitting unit shown in FIG. 9 is merely exemplary, and the embodiments of the present disclosure are not limited thereto. For example, the at least one light emitting unit may be attached to the center of the torso portion (910) of the transforming robot 900.

In an embodiment, the transforming robot 900 is not limited to the robot form shown in FIG. 9, and may be designed in various forms. In an embodiment, the positions of the plurality of joint portions 920, 922, 924 and 926 of the transforming robot 900 can be adjusted. For example, by moving and/or rotating the plurality of joint portions 920, 922, 924 and 926 in various directions, the overall shape of the transforming robot 900 may be altered. For example, the transforming robot 900 may transform from a robot form to another form (e.g., a car, a train) by manipulating the positions of the plurality of joint portions 920, 922, 924 and 926.

In an embodiment, the transforming robot 900 may include a processor, a communication unit, a drive motor functionally connected to the plurality of joint portions 920, 922, 924 and 926, and a battery electrically connected to the drive motor. Hereinafter, it can be understood that the operations of the transforming robot 900 are performed substantially by the processor.

In an embodiment, the transforming robot 900 may include a memory. At least one performance scenario may be stored in the memory of the transforming robot 900. The at least one performance scenario may be stored in the memory during a manufacturing process of the transforming robot 900, or may be received from the server 220 through the user device 230 and stored in the memory.

In an embodiment, the transforming robot 900 may receive, from the user device 230, a control signal instructing the production of one of the at least one performance scenario. For example, the control signal may be generated based on metadata received by the user device 230 from the server 220, or may be generated independently by the application 505 installed on the user device 230.

In an embodiment, the transforming robot 900 may produce the performance scenario stored in the memory based on the control signal. For example, the transforming robot 900 may use the drive motor to perform an action (e.g., arm waving or walking) according to the performance scenario. For example, the transforming robot 900 may use the drive motor to move the plurality of joint portions 920, 922, 924 and 926 and emit light of a predetermined color through the light emitting unit. In an embodiment, the transforming robot 900 may further include a speaker. The transforming robot 900 may receive a sound control signal from the user device 230 and output a predetermined sound through the speaker based on the control signal.

In an embodiment, the transforming robot 900 may include a separate button for performing a predetermined action. The transforming robot 900 may receive user input through the button.

The transforming robot 900 may perform actions according to the performance scenario in response to an input through the button, without receiving a control signal. The performance scenario may be stored in advance in the memory.

The processes of a method or algorithm described in connection with the embodiments disclosed herein may be embodied directly in hardware, in a software module executed by hardware, or in a combination of the two. The software module may reside in RAM (Random Access Memory), ROM (Read Only Memory), EPROM (Erasable Programmable ROM), EEPROM (Electrically Erasable Programmable ROM), flash memory, hard disk, a removable disk, a CD-ROM, or any other form of computer-readable storage medium known in the art.

Various embodiments according to the present disclosure may be implemented as software including one or more instructions stored in a storage medium (e.g., a memory) readable by a machine. For example, a processor (e.g., the processor 700 or 800) of the machine may call at least one instruction among the one or more instructions from the storage medium and then may execute the at least one instruction. This enables the machine to operate to perform at least one function depending on the called at least one instruction. The one or more instructions may include a code generated by a complier or a code executable by an interpreter.

The machine-readable storage medium may be provided in the form of a non-transitory storage medium. Herein, “non-transitory” just means that the storage medium is a tangible device and does not include a signal (e.g., electromagnetic waves), and this term does not distinguish between the case where data is semipermanently stored in the storage medium and the case where the data is temporarily stored. For example, the “non-transitory storage medium” may include a buffer in which data is temporarily stored.

According to an embodiment, a method according to various embodiments disclosed herein may be provided to be included in a computer program product. The computer program product may be traded between a seller and a buyer as a product. The computer program product may be distributed in the form of a machine-readable storage medium (e.g., compact disc read only memory (CD-ROM)) or may be distributed (e.g., downloaded or uploaded), through an application store (e.g., PlayStore™), directly between two user devices (e.g., smartphones), or online. In the case of on-line distribution, at least a part of the computer program product (e.g., a downloadable app) may be at least temporarily stored in the machine-readable storage medium such as the memory of a manufacturer's server, an application store's server, or a relay server, or may be temporarily generated.

Although an embodiment of the present disclosure are described with reference to the accompanying drawings, it will be understood by a person with ordinary skill in the art to which the present disclosure pertains that the present disclosure may be carried out in other detailed forms without changing the scope and spirit or the essential features of the present disclosure. Therefore, the embodiments described above are provided by way of example in all aspects, and should be construed not to be restrictive.

What is claimed is:

1. A user device configured to produce lighting effects of a video offered through a VOD service, comprising:
a communication unit configured to communicate with a server and a receiving device;
a memory; and
a processor electrically connected to the communication unit and the memory,
wherein the processor is configured to
acquire content-related information and playing time of the video,
request and receive at least one piece of metadata from the server based on the content-related information,
identify first metadata corresponding to the playing time among the at least one piece of metadata,
generate a light emission control signal based on the first metadata, and
transmit the light emission control signal to the receiving device.

2. The user device of claim 1, further comprising:
a display,
wherein the processor is further configured to receive the playing time from a user through the display.

3. The user device of claim 2,
wherein the at least one piece of metadata includes at least one piece of color information and at least one timecode.

4. The user device of claim 3,
wherein the content-related information includes performance information, and
the performance information includes at least one of performance ID, performance title, performance date and time, and at least one piece of stage information.

5. The user device of claim 4,
wherein the at least one piece of metadata is defined in advance for each of the at least one piece of stage information.

6. A method for producing lighting effects of a video offered through a VOD service, comprising:
a process of acquiring, by a user device, content-related information and playing time of the video;
a process of requesting, by the user device, at least one piece of metadata from a server based on the content-related information;
a process of receiving, by the user device, the at least one piece of metadata from the server;
a process of identifying, by the user device, first metadata corresponding to the playing time among the at least one piece of metadata and generating a light emission control signal based on the first metadata; and
a process of transmitting, by the user device, the light emission control signal to a receiving device.

7. The method of claim 6,
wherein the process of acquiring the playing time includes a process of receiving, by the user device, the playing time from a user through a display.

8. The method of claim 7,
wherein the at least one piece of metadata includes at least one piece of color information and at least one timecode.

9. The method of claim 8,
wherein the content-related information includes performance information, and
the performance information includes at least one of performance ID, performance title, performance date and time, and at least one piece of stage information.

10. The method of claim 9,
wherein the at least one piece of metadata is defined in advance for each of the at least one piece of stage information.

11. The method of claim 10,
wherein the process of generating, by the user device, the light emission control signal includes:
a process of generating, by the user device, the light emission control signal based on newly acquired playing time, upon acquiring the new playing time; and
a process of stopping, by the user device, the lighting effects when the video is ended.

12. The method of claim 11,
wherein the at least one piece of metadata is in a format of JavaScript Object Notation (JSON).

13. The method of claim 12,
wherein the receiving device includes a processor, a memory, and a light emitting unit, and
the processor emits light of a color corresponding to the light emission control signal through the light emitting unit.

14. The method of claim 12,
wherein the receiving device is a toy including at least one joint with adjustable positioning and a processor and further including at least one of a drive motor configured to drive the at least one joint, a light emitting unit, or a speaker, and
the processor is configured to
receive at least one of the light emission control signal, an operation control signal, or a sound control signal from the user device,
emit light of a color corresponding to the light emission control signal through the light emitting unit upon receiving the light emission control signal,
drive the at least one joint to perform a predetermined operation upon receiving the operation control signal, and
output sound through the speaker based on the sound control signal upon receiving the sound control signal.

15. A user device configured to produce lighting effects of a live-streamed performance video, comprising:
a communication unit configured to communicate with a server and a receiving device;
a memory; and
a processor electrically connected to the communication unit and the memory,
the processor is configured to
acquire performance information and playing time of the performance video,
request, from the server, first metadata corresponding to a first stage based on the performance information,
download the first metadata from the server,
check stage information of a stage produced in real time during the performance,
generate a light emission control signal based on the playing time and the first metadata in response to the first stage being produced during the performance, and
transmit the light emission control signal to the receiving device.
